(19) United States
(12) Patent Application Publication
(10) Pub. No.: US 2004/0201984 A1
(43) Pub. Date: Oct. 14, 2004

(54) Electroluminescent lighting device

(75) Inventors: Leslie L. Eaton, Houston, TX (US); Donald A. Barr, League City, TX (US)

Correspondence Address: WONG, CABELLO, LUTSCH, RUTHERFORD & BRUCCULERI,, P.C., 20333 SH 249, SUITE 600, HOUSTON, TX, 77070, US

(73) Assignee: Muniz Engineering, Inc., Houston, TX

(21) Appl. No.: 10/819,787

(22) Filed: Apr. 7, 2004

Related U.S. Application Data
(60) Provisional application No. 60/461,393, filed on Apr. 9, 2003.
(60) Provisional application No. 60/461,395, filed on Apr. 9, 2003.
(60) Provisional application No. 60/470,939, filed on May 15, 2003.

(51) Int. Cl. G01D 11/28

(52) U.S. Cl. 362/157

(57) ABSTRACT

Electroluminescent lighting devices are described having an external electroluminescent light source coupled to a power source enclosed in a housing for use in illuminating dark areas. In one embodiment the device is portable and can be carried in a pocket or purse. In another embodiment the device is attachable to an area where low level lighting is beneficial, such as a hospital bed side-rail or gurney. In another embodiment, the device may be used as a source of emergency lighting along an emergency exit.

This application is related to three U.S. provisional patent applications: (1) “Lighted Hospital Bed Side Rails” (serial No. 60/461,393), filed Apr. 9, 2003; (2) “Portable Electroluminescent Lighting Unit” (serial No. 60/461,395), filed Apr. 9, 2003; and (3) Supplemental Emergency Lighting System“(serial No. 60/470,939), filed May 15, 2003, all of which are hereby incorporated by reference.

### BACKGROUND

The invention relates to the area of electroluminescent lighting. More specifically, but not by way of limitation, the invention is directed to an electroluminescent lighting device for use in illuminating dark areas. In one embodiment, the device is portable and can be carried in a pocket or purse. In another embodiment, the device is attachable to an area where low level lighting is beneficial, such as a hospital side rail. In yet another embodiment, the device may be implemented as an emergency lighting source for use along emergency exits.

It can be appreciated that lighting techniques have been in use for years, enabling individuals to illuminate darkened areas and spaces. Conventional battery-operated flashlights, kerosene lamps, and chemically activated light sticks are well-known portable light sources which typically provide lighting for short periods of time. Other lighting techniques have been specifically adapted to a particular environment. Some purses have illuminating devices installed in an interior compartment. Car visors may contain illuminated mirrors which activate when the user pulls down the visor. Other objects, such as computers, watches, emergency exit signs and stereo displays contain an internal lighting source, allowing the user to illuminate the device without the need for additional external lighting.

However, there are still many problems in the field of temporary lighting. Kerosene lanterns and incandescent light bulbs produce heat which creates a fire safety hazard. The fragile nature of incandescent light bulbs also reduces the reliability of the light source and creates the potential for broken glass. “Chemiluminescent” sticks, another form of temporary lighting, have a short, non-renewable duration of illumination, creating the need to carry multiple sticks. These chemically activated illuminating sticks are also prone to activation if accidentally abused or bent.

Thus, it would be beneficial to provide a lighting device capable of withstanding moderate abuse while emitting low levels of heat for significantly longer periods of time than existing devices. It would be a further benefit to provide these capabilities in a device that is inherently safer and less costly to operate than existing lighting devices.

### SUMMARY

Electroluminescent lighting devices are described having an external electroluminescent light source coupled to a power source enclosed in a housing for use in illuminating dark areas. In one embodiment the device is portable and can be carried in a pocket or purse. In another embodiment the device is attachable to an area where low level lighting is beneficial, such as a hospital bed side-rail or gurney. In another embodiment, the device may be used as a source of emergency lighting along an emergency exit.

### BRIEF DESCRIPTION OF THE DRAWINGS

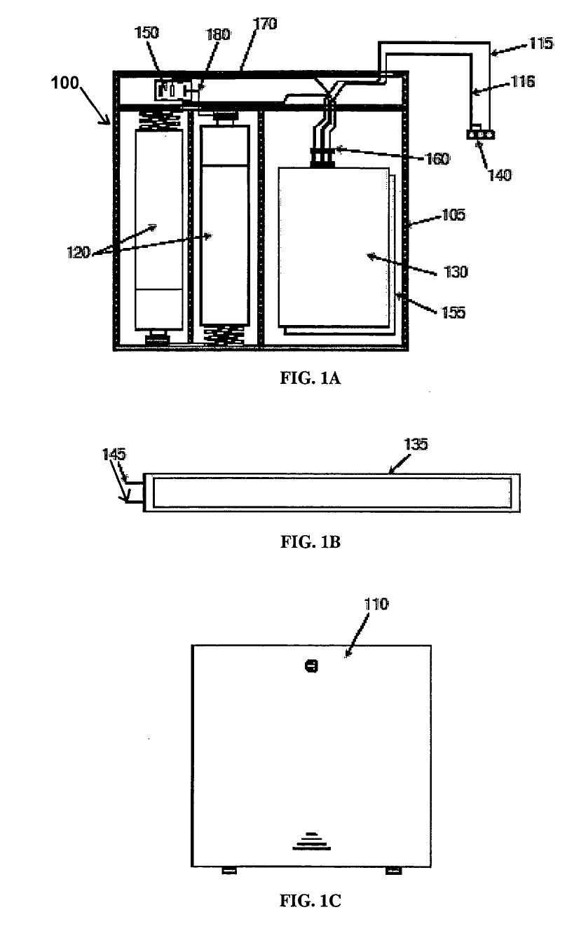

A better understanding of the invention can be had when the following detailed description of the preferred embodiments is considered in conjunction with the following drawing in which FIG. 1A shows the internal structure of an electroluminescent lighting device in accordance with the invention. FIG. 1B shows an electroluminescent strip for use with the embodiment of FIG. 1A. FIG. 1C shows a cover for the container of FIG. 1A.

### DETAILED DESCRIPTION

An electroluminescent lighting device is described. While the device is described herein in a limited number of embodiments, those of ordinary skill in the art will recognize that an electroluminescent lighting device in accordance with the invention may have many other uses not detailed herein. Accordingly, the embodiments described herein are illustrative only and are not to be considered limiting in any respect.

Referring to FIGS. 1A, 1B and 1C, electroluminescent lighting device (“EL device”) 100 in accordance with one embodiment of the invention comprises housing 105 with power source 120, inverter 130, connectors 160 and 140, leads 180, 170, 115, and 116. EL device 100, in accordance with one embodiment of the invention, further comprises electroluminescent light source 135 with connector pins 145, as shown in FIG. 1B, and removable cover 110. Removable cover 110 may be attached to housing 105 by a screw. In another embodiment removable cover 110 is attached to housing 105 by matching grooves which are known in the art and which allow removable cover 110 to slide into and lock with housing 105. In yet another embodiment removable cover 110 and housing 105 are attached sufficiently tightly to create a waterproof enclosure. In this embodiment it is suggested that an additional O-ring or other flexible surrounding may be inserted between housing 105 and removable cover 110 in order to create a sufficiently tight seal. Removable cover 110 and housing 105 may be constructed of a sturdy plastic or other material sufficient to withstand moderate abuse. In another embodiment, removable cover 110 and housing 105 may be composed of metal or steel sufficiently strong to withstand more extreme conditions. In yet another embodiment, housing 105 is further enclosed by a rubberized sheath which allows EL device 100 to withstand abuse. One of ordinary skill in the art will recognize that the type of material used to construct housing 105 in accordance with the invention depends upon the use and/or environment in which it is to operate.

In one embodiment housing 105 may contain inverter 130 fixably attached to the interior of housing 105 with binding substance 155. Inverter 130 may be a standard inverter as is commonly known in the art. Binding substance 155 may comprise any adhesive which would couple inverter 130 to rigid portable housing 105. In one embodiment the binding substance 155 may be glue. In another embodiment binding substance 155 may be double sided adhesive tape.

Referring to FIG. 1A, connector 160 couples inverter 130 to leads 170, 115, and 116. Leads 115 and 116 are further coupled to connector 140. Lead 170 couples connector 160 to power source 120 to allow current to flow from power source 120 to inverter 130. In one embodiment connectors 160 and 140 are three position socket connectors. In another embodiment, connectors 160 and 140 are merely two position socket connectors. As will be known to one of ordinary skill in the art, connectors 160 and 140, together with leads 115 and 116, allow for a continuous current flow between inverter 130 and electroluminescent light source 135. In varying embodiments of the device, it is generally contemplated that leads 170, 115, and 116 may be ordinary copper leads as known in the art.

In one embodiment power source 120 may comprise a pair of batteries of relatively small size, such as commonly known “AAA,” “AA,” “C,” “D,” or “9-volt” batteries. In other embodiments power source 120 may be a 110 volts alternating current (“VAC”), 24 VAC or 12 volts direct current (“VDC”) rechargeable power source. In another embodiment power source 120 may comprise a rechargeable battery pack. Depending on the environment in which the device is to be used, power source 120 may be of differing sizes and capable of differing power outputs. By way of example only, in one contemplated embodiment, power source 120 may be a simple battery pack comprising two 1.5 volt “AA” batteries. In this embodiment the EL device will be small and can be easily carried in a pocket or purse. Alternatively, in another contemplated embodiment, power source 120 may be a larger, 12 VDC, 24 VAC or 110 VAC rechargeable power source which may be plugged directly into a wall socket. In yet another embodiment, power source 120 may be a conventional 110 VAC power source which may be mounted on a vehicle such as a hospital bed rail or gurney.

Referring again to FIG. 1A, switch 150 is mounted in housing 105. Power source 120 is coupled to switch 150 by lead 180. Lead 180 is similar to leads 115, 116, and 170 discussed above. In one embodiment switch 150 is a manually activated switch. In another embodiment switch 150 may be coupled to a timing device by which the switch may be activated at a particular time each day. In yet another contemplated embodiment, switch 150 may be coupled to an alarm device or system whereby switch 150 is activated upon the occurrence of an emergency wherein additional lighting may be required. Thus, in areas such as hospitals, office buildings, manufacturing facilities, and other areas where sudden loss of light could lead to injury, switch 150 may be automatically activated when a sudden loss of light occurs to provide supplemental emergency safety lighting to assist personnel in orientation and navigation to safety.

Referring to FIGS. 1A and 1B, connector 140 may be coupled to various embodiments of electroluminescent light source 135 with pins 145. Electroluminescent lamps (hereinafter “EL lamps”) do not produce heat and require less current than incandescent or fluorescent lamps. As is commonly known in the art, EL lamps can be produced in a variety of shapes, lengths, and colors. Further, EL lamps can be applied to a variety of shapes and surface with simple adhesives or other commonly known coupling methods. Thus, in one contemplated embodiment, light source 135 in EL device 100 may comprise an EL lamp which may be operatively mounted along the baseboards in a hospital or other artificially lit structure. In another embodiment, light source 135 in EL device 100 may comprise an EL lamp mounted on the base frame of a hospital bed or nightstand, providing illumination to the surrounding floor and bed area. Thus visualization of potential trip hazards is improved and the need for nurses to carry a flashlight while making rounds during evening and/or dark periods is reduced. An added benefit to EL device 100 is that such hazards and obstacles may be illuminated while the low level light is still conducive to sleep.

Referring again to FIG. 1B, light source 135 may be an electroluminescent light strip or a small electroluminescent panel. Electroluminescent light strips (hereinafter “EL light strips”) are known in the art. Various manufacturers include Oryon Technologies of Dallas, Tex., MKS Quantiflex of Bridgeton, N.J. as well as the Durel division of the Rogers Corporation of Rogers, Conn., among others. EL light strips may be of varying sizes and colors, and, depending on the length and width, consume varying amounts of power. By way of example only, one embodiment of EL device 100 may comprise an EL strip that is 8.5 inches long and 0.5 inches wide. In this embodiment, the power source 120 comprises two 1.5 volt “AA” batteries. In tests, this embodiment generated approximately 60 hours of continuous usable light and an additional 12 hours of illumination of the EL light strip (for a total of 72 hours of illumination). In another embodiment power source 120 comprises a rechargeable battery pack which is automatically activated when a power outage occurs. In one embodiment, the battery pack comprising power source 120 may be plugged into a standard AC power outlet and outfitted to detect such a power outage. Light source 135 in this embodiment may comprise an EL light strip or an EL lamp mounted to a structure such as a hospital bed side rail, an emergency escape route wall, or along stairwell handrails in a business or office building. In this embodiment, upon restoration of power to the structure being lighted, EL device 100 detects the power restoration, automatically switches itself off, and begins recharging power source 120. The present invention contemplates that varying embodiments may further incorporate directional arrows overlaid on light source 135 mapping the emergency exit route.

In other embodiments, light source 135 may comprise EL light strips of various sizes to which a hook & loop fastener has been attached, allowing the light source to be temporarily affixed to various objects. It is contemplated that these embodiments will allow emergency workers to comfortably affix light source 135 to their clothing or medical bag while the remainder of the device may be placed safely in a pocket or other compartment, or attached to a belt. Additionally, such embodiments may be advantageous to pilots, astronomers, fishermen, campers, and other individuals needing a portable lighting device which gives off low levels of light. Such embodiments also may be used on tents, name tags, caps, clothing, doorways, bicycles, furniture, office equipment, industrial equipment, or to light the wheel well of a vehicle while changing a tire.

While the embodiment described above describes the use of a hook & loop fastener, other methods of attaching the EL light strip are contemplated. For example, the light strip may be attached using commonly known hook and eye enclosures, magnets, zippers, buttons, or even temporary double sided adhesive tape.

Various changes in the materials and structure of the illustrated embodiments are possible without departing from the scope of the claims. Thus, while the invention has been disclosed with respect to a limited number of embodiments, numerous modifications and variations will be appreciated by those skilled in the art. It is intended, therefore, that the following claims cover all such modifications and variations that may fall within the true spirit and scope of the invention.

What is claimed is:

1. A portable electroluminescent lighting system comprising:
a housing;
a power source fixedly enclosed in said housing;
at least one electroluminescent light source external to the housing operatively coupled to the power source; and
actuation means for electrically coupling and isolating the power source from the at least one external electroluminescent light source.

2. The lighting system of claim 1 wherein the housing comprises a rigid box having at least one removable cover.

3. The lighting system of claim 1 wherein the housing comprises a rigid plastic material.

4. The lighting system of claim 1 wherein the housing comprises steel.

5. The lighting system of claim 1 further comprising a rubberized sheath surrounding the housing.

6. The lighting system of claim 1, wherein the power source comprises:
at least one battery;
an inverter electrically coupled to the at least one battery;
a connector adapted to electrically couple an electroluminescent light element to the inverter; and
a switch means for electrically coupling the electroluminescent light element to the inverter, said switch means coupled between the inverter and the connector.

7. The lighting system of claim 1, wherein the electroluminescent light source comprises a detachable electroluminescent lamp.

8. The lighting system of claim 1, wherein the electroluminescent light source comprises a detachable electroluminescent light strip.

9. An electroluminescent lighting device for use in lighting a human support structure comprising:
a housing, fixedly attached to the human support structure;
a power source fixedly enclosed in said housing;
at least one electroluminescent light source external to the housing operatively coupled to the power source;
actuation means for electrically coupling and isolating the power source from the at least one external electroluminescent light source; and
mounting means for fixably mounting the electroluminescent light source to the human support structure.

10. The electroluminescent lighting device of claim 9, wherein the human support structure comprises a hospital bed.

11. The electroluminescent lighting device of claim 9, wherein the human support structure comprises a hospital gurney.

12. The electroluminescent lighting device of claim 9, wherein the power source comprises:
input power means for receiving alternating current;
a converter coupled to the input power means and adapted to convert alternating current to direct current; and
a battery coupled to an output of the converter;
wherein the converter is adapted to maintain the battery in a charged state so long as the input power means is coupled to an alternating current source.

13. The electroluminescent lighting device of 9, wherein the electroluminescent light source comprises a detachable electroluminescent light strip.

14. The electroluminescent lighting device of claim 9, wherein the electroluminescent light source comprises an electroluminescent lamp.

15. An emergency electroluminescent lighting device comprising:
a housing;
a power source fixedly enclosed in said housing;
at least one electroluminescent light source external to the housing operatively coupled to the power source;
actuation means for automatically electrically coupling and isolating the power source from the at least one external electroluminescent light strip; and
adhesive means for coupling the at least one electroluminescent light strip along an emergency escape route.

16. The emergency electroluminescent lighting device of claim 15 wherein the electroluminescent light source comprises an electroluminescent strip.

17. The emergency electroluminescent lighting device of claim 15 wherein the electroluminescent light source comprises an electroluminescent lamp.
